(19) United States
(12) Patent Application Publication
(10) Pub. No.: US 2009/0253610 A1
(43) Pub. Date: Oct. 8, 2009

(54) Fabric softening composition

(76) Inventors: Gustavo Kume, Sao Paulo (BR); Manlio Gallotti, Sao Paulo (BR); George Italo Pitombeira Nunes, Sao Paulo (BR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/990,647

(22) PCT Filed: Aug. 19, 2006
(86) PCT No.: PCT/EP2006/008193

§ 371 Date: Apr. 24, 2009

(30) Foreign Application Priority Data
Aug. 27, 2005 (EP) 05018646.9

(51) Int. Cl. C11D 3/26

(52) U.S. Cl. 510/522; 510/527

(57) ABSTRACT

The invention relates to a fabric softener which has a clear appearance. The composition essentially consists of 1 to 20% of an alkyl or hydroxyethyl quaternary ammonium compound, 0.1 to 10% of a long chain alkyl amine or of a long chain alkyl amido propyl betaine, the rest being a carrier like water.

The present invention relates to fabric softening compositions, preferably translucent, clear or transparent conditioners, which in addition to a cationic fabric softener comprise a sec-alkane sulfonate and a tertiary amine or an amphoteric surfactant.

Fabric softening compositions are known in the art for imparting benefits such as softness and/or antistatic properties to the treated fabric. However, nowadays, consumer acceptance of fabric softening compositions is determined not only by the performance achieved with these products but also by the aesthetics associated therewith. Viscosity of the product is therefore an important aspect of the successful formulation of such commercial products, stable low to medium viscosities being highly preferred by consumers.

Clear fabric softeners are usually achieved through the use of high concentrations of organic solvents. Viscous solutions are usually prepared by the addition of gelling/thickening agent. However we have found that certain viscous clear composition can be produced without the use of organic solvents, without the need to add a thickening/gelling system. The reduction or elimination of a thickening/gelling system will reduce the cost of the formulation. In addition the organic solvents used to produce clear fabric softening compositions normally have some negative impact on the odour of final formulations.

From GB 2 007 735 certain cationic surfactant compositions are known which contain a quaternary ammonium salt having one long chain alkyl group and an anionic surfactant which may be alkanesulfonate. In addition these compositions may contain oxalkylated fatty alcohols on oxalkylated fatty acids. The presence, and consequent benefits, of tertiary amines or amphoteric surfactants are not disclosed therein.

Clear fabric softener compositions containing a quaternary ammonium compound are also disclosed in U.S. Pat. No. 5,466,394; U.S. Pat. No. 4,751,009; U.S. Pat. No. 6,884,767 and WO 02/092792.

It is an object of the invention to provide a softening composition that shows a clear appearance.

Clear fabric softener compositions containing high levels or organic solvent are well known in the art. These compositions generally have high organic solvent concentrations which are needed to provide clarity, but have a high negative odour and, usually, poor softening performance.

The present invention is based on the surprising discovery that it is possible to obtain a stable clear fabric softener composition that performs well on softening fabrics, which comprises a cationic surfactant, a sec. alkanesulfonate and a tert. amine or an amphoteric surfactant.

The present invention is a fabric softening composition comprising: A fabric softener composition essentially consisting
a) 1 to 20% by weight of a compound of the formula I

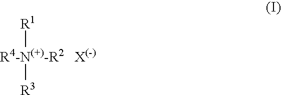

wherein R¹ is C₈-C₂₂-alkyl or C₈-C₂₂-alkenyl, R², R³ are independently C₁-C₄-alkyl, R⁴ is C₁-C₄-alkyl or hydroxyethyl, and X is an anion,
b) 0.1 to 5% by weight of a secondary alkane sulfonate having 8 to 22 carbon atoms,
c) 0.1 to 10% by weight of a tertiary amine of the formula

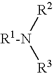

wherein R¹ is C₈-C₂₂-alkyl or C₈-C₂₂-alkenyl and R² and R³ are C₁-C₄-alkyl or hydroxyethyl, or
d) 0.1 to 10% by weight of an amphoteric surfactant of the formula

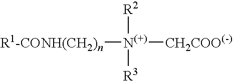

wherein R¹ is C₈-C₂₂-alkyl or C₈-C₂₂-alkenyl, R² and R³ are independently C₁-C₄-alkyl, n is a number between 1 and 3 and
e) a liquid carrier.

In another aspect of the invention, there is provided a method of treating fabric which comprises the step of contacting said fabric in the rinse cycle of a fabric washing machine with an aqueous medium containing a composition as defined herein.

### Cationic Fabric Softener

A cationic fabric softener, or mixtures thereof, is an essential ingredient of the invention. Typical levels of the cationic fabric softener within the softening compositions are 2% to 20% by weight, preferably from 2% to 15% by weight, and more preferably from 2% to 10% by weight of the composition.

Preferred quaternary ammonium compounds of formula (I) are those wherein R¹ is C₈-C₂₂-alkyl and R², R³ and R⁴ all are methyl.

Non-limiting examples of the anion A include chloride or methyl sulfate, preferably chloride.

The alkyl, or alkenyl chain R¹ may be straight or branched.

A specific example of a mixture of quaternary ammonium compounds suitable for use in the aqueous fabric softening compositions herein is 80% (by weight of total cationic active content) of C₁₆ trimethyl ammonium X⁻ and 20% (by weight of total cationic active content) of C₁₈ trimethyl ammonium X⁻, wherein X⁻ is preferably chloride.

Another possible quaternary ammonium compound suitable for use in aqueous fabric softening compositions is C_{12/14} dimethyl hydroxyalkyl ammonium X⁻, wherein X⁻ is preferably chloride.

The sec. alkanesulfonates defined as component b) are widely known as such in the art. The compositions according to the present invention contain 0.1 to 5% by weight of such sec. alkanesulfonates.

The third component in the fabric softener composition is either a tertiary amine or an amphoteric surfactant as defined above.

For the preceding fabric softening agents, the pH of the liquid compositions herein is a preferred parameter of the present invention. Indeed, the pH influences the phase stability of the quaternary ammonium or amine precursors compounds, both at instant appearance and in prolonged storage conditions. The pH, as defined in the present context, is measured in the neat compositions at 20° C. For optimum phase stability of these compositions, the neat pH, measured in the above-mentioned conditions, is ideally in the range of from 2 to 5. The pH of these compositions herein can be regulated by the addition of acids such as Bronsted or Lewis ones.

Examples of suitable acids include the inorganic mineral acids, carboxylic acids, in particular the low molecular weight (C₁-C₅)-carboxylic acids, and alkylsulfonic acids. Suitable inorganic acids include HCl, H₂SO₄, HNO₃ and H₃PO₄. Suitable organic acids include formic, acetic, citric, methylsulfonic and ethylsulfonic acid. Preferred acids are citric, hydrochloric, phosphoric, formic, methylsulfonic acid, and benzoic acids. Especially preferred is citric acid.

The softening composition of the invention will also comprise a liquid carrier in an amount up to 100% by weight. Suitable liquid carriers are selected from water, organic solvents and mixtures thereof. The liquid carrier employed in the instant compositions is preferably at least primarily water due to its low cost, safety, and environmental compatibility.

Mixtures of water and low molecular weight (by “low molecular weight” we mean less than 200) organic solvent may be used. Preferred low molecular weight organic solvents are; monohydric alcohol, such as ethanol, propanol, iso-propanol or butanol; dihydric alcohol, such as glycol; trihydric alcohols, such as glycerol, and polyhydric (polyol) alcohols.

### Optional

The composition may also contain optional components which may be suitable for further improving the aesthetic appearance of the fabrics treated therewith. Suitable optional components include polyethylene glycols, additional fabric softening components, enzymes, cyclodextrin/perfume complexes and free perfume delivery systems, and mixtures thereof, preferably in the form of an alkali metal salt, ideally sodium.

### Polyethylene Glycol

A polymeric material which can optionally be included is polyethylene glycol (PEG). When used, PEG may provide an increase in the viscosity stability upon storage of the composition of the invention. Typical molecular weight ranges for these purposes range from 500 to 100,000. Preferably from 1,000 to 50,000, more preferably from 1,500 to 10,000. A most preferred molecular weight is 4,000.

When present, typical levels of polyethylene glycols are from 0.01 to 1% by weight, preferably from 0.05% to 0.5% by weight of the composition.

### Additional Components

The composition may also optionally contain additional additives and adjuvants which for example include, but are not limited by, surfactant concentration aids, electrolyte concentration aids, antioxidants and reductive agents, emulsifiers, bactericides, colorants, perfumes, preservatives, optical brighteners, functional polymers, anti ionisation agents, chelants, natural and synthetic extracts and antifoam agents.

### Stabilizers

In a preferred feature according to this invention the fabric softening composition is free of organic solvents and/or other anionic, nonionic or cationic surfactants than those defined under a), b), c) and d) above.

Stabilizers may also optionally be added. When used, said stabilizer will help achieving the desired finished product viscosity as well as stabilizing the finished product upon storage. Stabilizers are typically selected from single long chain alkyl cationic surfactants, non-ionic alkoxylated surfactants, amine oxides, fatty acids, and mixtures thereof, typically used at a level of from 0 to 15% by weight of the composition.

### Electrolyte Stabilizers

Inorganic viscosity control agents which can also act like or augment the effect of the stabilizers, include water-soluble, ionisable salts which can also optionally be incorporated into the compositions of the present invention. Incorporation of these components to the composition must be processed at a very slow rate. A wide variety of ionisable salts can be used. Examples of suitable salts are the halides of the Group IA and IIA metals of the Periodic Table of the Elements, e.g., calcium chloride, magnesium chloride, sodium chloride, potassium bromide, and lithium chloride. The ionisable salts are particularly useful during the process of mixing the ingredients to make the compositions herein, and later to obtain the desired viscosity. The amount of ionisable salts used depends on the amount of active ingredients used in the compositions and can be adjusted according to the desires of the formulator.

Alkylene polyammonium salts can be incorporated into the composition to give viscosity control in addition to or in place of the water-soluble, ionisable salts above. In addition, these agents can act as scavengers, forming ion pairs with anionic detergent carried over from the main wash, in the rinse, and on the fabrics, and may improve softness performance. These agents may stabilize the viscosity over a broader range of temperature, especially at low temperatures, compared to the inorganic electrolytes.

Specific examples of alkylene polyammonium salts include 1-lysine monohydrochloride and 1,5-diammonium 2-methyl pentane dihydrochloride. The present invention also encompasses a method for treating fabrics which comprises the step of containing said fabrics in the rinse cycle with an aqueous medium containing a composition as defined hereinbefore. Preferably, the aqueous medium is at a temperature between 2 to 40° C., preferably between 5 to 25° C.

The invention is illustrated in the following non limiting examples, in which all percentages are on an active weight % basis unless otherwise stated.

### EXAMPLE 1

### Fabric Softener Formulation with a Mixture of Cationic Compounds and Tertiary Amine

| Raw Material | Example 1 |
|---|---|
| Cetyl Trimethyl Ammonium Chloride | 3.1 |
| Stearyl Trimethyl Ammonium Chloride | 0.8 |
| Tallow Fatty Amine Ethoxylate with 2EO | 1.8 |
| Sec. Alkane Sulfonate | 0.8 |
| Citric Acid | 0.5 |
| Water | qsp |

### EXAMPLE 2

### Fabric Softener Formulation with a Tertiary Amine

| Raw Material | Example 2 |
|---|---|
| Cetyl Trimethyl Ammonium Chloride | 3.5 |
| Tallow Fatty Amine Ethoxylate with 2EO | 1.6 |
| Sec. Alkane Sulfonate | 0.8 |
| Sequest HEDP | 0.1 |
| Citric Acid | 0.4 |
| Water | qsp |

### EXAMPLE 3

### Fabric Softener Formulation with an Amphoteric Surfactant

| Raw Material | Example 3 |
|---|---|
| Stearyl Trimethyl Ammonium Chloride | 3.9 |
| C₁₅/C₁₇ Alkyl Amido Propyl Betaine | 0.5 |
| Sec. Alkane Sulfonate | 0.8 |
| Sequest HEDP | 0.1 |
| Water | qsp |

### EXAMPLE 4

### Fabric Softener Formulation with Hydroxyethyl Quaternary Ammonium Compounds

| Raw Material | Example 4 |
|---|---|
| C₁₂/C₁₄ Alkyl Dimethyl Hydroxyethyl Ammonium Chloride | 3.9 |
| Tallow Fatty Amine Ethoxylate with 2EO | 1.6 |
| Sec. Alkane Sulfonate | 0.8 |
| Sequest HEDP | 0.1 |
| Citric Acid | 0.4 |
| Water | qsp |

1. A fabric softener composition consisting essentially of
a) 1 to 20% by weight of a compound of the formula I 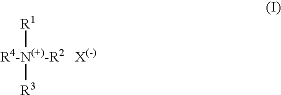
wherein R¹ is C₈-C₂₂-alkyl or C₈-C₂₂-alkenyl, R², R³ are independently C₁-C₄-alkyl, R⁴ is C₁-C₄-alkyl or hydroxyethyl, and X is an anion,
b) 0.1 to 5% by weight of a secondary alkane sulfonate having 7 to 21 carbon atoms,
c) 0.1 to 10% by weight of a tertiary amine of the formula 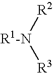
wherein R¹ is C₈-C₂₂-alkyl or C₈-C₂₂-alkenyl and R² and R³ are C₁-C₄-alkyl or hydroxyethyl, and
d) a liquid carrier.

2. A fabric softener, according to claim 1, wherein compound of formula (I) is a mixture of C₁₆ trimethyl ammonium chloride and C₁₈ trimethyl ammonium chloride.

3. The fabric softener of claim 1 wherein the secondary alkane sulfonate has a carbon chain of 14 to 17 carbon atoms.

4. The fabric softener of claim 1, wherein the tertiary amine is a tallow fatty amine ethoxylated with 2 mols of ethylene oxide.

5. The fabric softener of claim 1, wherein the final fabric softener formulation has presents a clear, transparent or translucent appearance.

6. The fabric softener of claim 1, further comprising additives and adjuvants.

7. A method for softening a fabric, said method comprising contacting the fabric during a rinse cycle of a fabric washing machine with an aqueous medium comprising the fabric softener of claim 1.
